(19) United States
(12) Patent Application Publication
(10) Pub. No.: US 2016/0149727 A1
(43) Pub. Date: May 26, 2016

(54) VHT-SIG-B BASED DECISION FEEDBACK CHANNEL ESTIMATION

(71) Applicant: QUALCOMM Incorporated, San Diego, CA (US)

(72) Inventors: Zixia Hu, Sunnyvale, CA (US); Kai Shi, San Jose, CA (US); Chin-Hung Chen, San Jose, CA (US); Ning Zhang, Saratoga, CA (US)

(21) Appl. No.: 14/553,854

(22) Filed: Nov. 25, 2014

(51) Int. Cl. H04L 25/02; H04W 24/02

(52) U.S. Cl. CPC H04L 25/0202; H04W 24/02; H04W 84/12

(57) ABSTRACT

A method of determining a channel response of a communications channel. A computing device receives a data packet via the communications channel and generates a first channel estimation based on a first portion of a preamble of the received data packet. The computing device further generates a second channel estimation based on a second portion of the preamble and determines the channel response of the communications channel based, at least in part, on an average of the first and second channel estimations. For example, the first portion of the preamble may correspond with a Long Training Field (LTF), and the second portion of the preamble may correspond with a Very High Throughput Signal B (VHT-SIG-B) field.

### TECHNICAL FIELD

The present embodiments relate generally to wireless communications systems, and specifically to methods of improving the channel estimation for a wireless communications system.

### BACKGROUND OF RELATED ART

A wireless local area network (WLAN) may be formed by one or more access points (APs) that provide a wireless communication channel or link with a number of client devices or stations (STAs). Each AP, which may correspond to a Basic Service Set (BSS), periodically broadcasts beacon frames to enable any STAs within wireless range of the AP to establish and/or maintain a communication link with the wireless network. Once a connection is established, the STA and the AP may exchange data using one or more protocols defined by the IEEE 802.11 specification.

Digital modulation techniques are typically used to transmit data over a wireless channel. Moreover, estimating the properties of the wireless channel is a key component for successfully demodulating a received data signal. The IEEE 802.11 specification defines a long training field (LTF) to be included in the preamble of every data packet transmitted over the wireless network (e.g., L-LTF for 802.11a, HT-LTF for 802.11n and VHT-LTF for 802.11ac) and used for estimating channel state information (CSI). More specifically, the LTF typically includes a sequence of training data that is known to the receiver and can therefore be used to estimate the channel response of the wireless network. For example, the received training data may be compared with their known values to determine how the wireless channel affects (e.g., transforms) the transmitted data.

The quality of the channel estimation typically depends on the signal-to-noise ratio (SNR) at the receiver. For example, the channel estimation derived from training data in the LTF may be much less reliable for low-order modulation and coding schemes (MCSs) operating in a low SNR region.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method of determining a channel response of a communications channel is disclosed whereby a computing device first receives a data packet via the communications channel. The computing device generates a first channel estimation based on a first portion of a preamble of the received data packet, and further generates a second channel estimation based on a second portion of the preamble. The computing device then determines the channel response of the communications channel based, at least in part, on an average of the first and second channel estimations. For some embodiments, the first portion of the preamble may include a set of known data and the second portion of the preamble may include a set of user-specific data. For example, the first portion of the preamble may correspond with a Long Training Field (LTF), whereas the second portion of the preamble may correspond with a Very High Throughput Signal B (VHT-SIG-B) field (e.g., as defined by the IEEE 802.11ac specification).

For some embodiments, the computing device may generate the second channel estimation by first determining a hard (and/or soft) decision estimate for each data symbol of a received set of data symbols from the second portion of the preamble. The computing device may then compare the received data symbols with the hard (and/or soft) decision estimates to determine the second channel estimation. For example, the second channel estimation may correspond with a transformation to the hard (and/or soft) decision estimates which results in the received data symbols.

Further, for some embodiments, the computing device may determine the channel response of the communications channel based on a weighted average of the first channel estimation and the second channel estimation. For example, the first channel estimation and the second channel estimation may be given equal weight when a signal-to-noise ratio (SNR) of the communications channel is above a threshold level. On the other hand, the first channel estimation may be given greater weight than the second channel estimation when the SNR is equal to or below a threshold level.

The data packet may be received via a plurality of spatial streams (e.g., using MIMO signaling techniques). Thus, for some embodiments, the computing device may generate a third channel estimation based on a third portion of the preamble of the received data packet. The computing device may further determine an equivalent channel response based on an average of the first channel estimation and the second channel estimation. Finally, the computing device may determine the channel response of the communications channel based on a combination of the equivalent channel response and the third channel estimation.

The methods of operation disclosed herein allow a computing device (e.g., AP and/or STA) to determine the channel response of a communications channel based on different information fields of the preamble of a received data packet. More specifically, the embodiments herein may leverage the VHT-SIG-B field of a received data packet to augment the channel estimation derived from known training data included in the LTF (e.g., by conventional means). This may provide a more accurate and reliable channel estimation (e.g., as compared to prior solutions using only the LTF information).

### BRIEF DESCRIPTION OF THE DRAWINGS

The present embodiments are illustrated by way of example and are not intended to be limited by the figures of the accompanying drawings, where:

FIG. 1 shows a communications system in accordance with some embodiments.

FIG. 2 is a block diagram of a receiver for a communications device, in accordance with some embodiments.

FIG. 3 shows an example structure of a data packet preamble upon which the present embodiments may be implemented.

FIG. 4 is a block diagram of a channel evaluator, in accordance with some embodiments.

FIG. 5 shows a multiple-input multiple-output (MIMO) communications system in accordance with some embodiments.

FIG. 6 is a block diagram of a receiver for a MIMO communications device, in accordance with some embodiments.

FIG. 7 is a block diagram of a wireless communications device, in accordance with some embodiments.

FIG. 8 is an illustrative flow chart depicting a method of determining the channel response of a wireless communications channel, in accordance with some embodiments.

FIG. 9 is an illustrative flow chart depicting a method of determining the channel response of a MIMO communications channel, in accordance with some embodiments.

### DETAILED DESCRIPTION

The present embodiments are described below in the context of Wi-Fi enabled devices for simplicity only. It is to be understood that the present embodiments may be equally applicable for devices using signals of other various wireless standards or protocols. As used herein, the terms “wireless local area network (WLAN)” and “Wi-Fi” can include communications governed by the IEEE 802.11 standards, BLUETOOTH®, HiperLAN (a set of wireless standards, comparable to the IEEE 802.11 standards, used primarily in Europe), and other technologies used in wireless communications.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

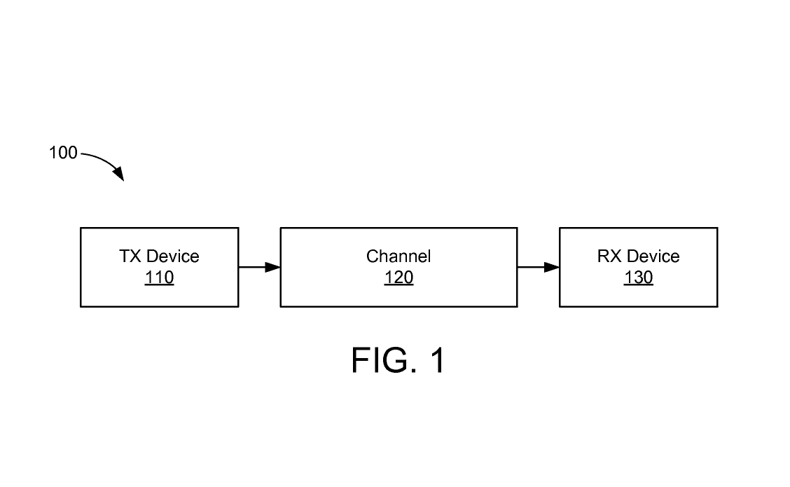

FIG. 1 shows a communications system 100 in accordance with some embodiments. A transmitting (TX) device 110 transmits a signal onto a channel 120, and a receiving (RX) device 130 receives the signal via the channel 120. The TX device 110 and RX device 130 may be, for example, computers, switches, routers, hubs, gateways, and/or similar devices. For some embodiments, the communications system 100 is a wireless local area network (WLAN) based on the IEEE 802.11 standard (e.g., the channel 120 is a wireless medium), although other wireless communication standards may be employed by system 100. In other embodiments, the channel may be a wired link.

The channel 120 may introduce noise and/or other types of interference into data signals transmitted by the TX device 110. Thus, to properly decode a received data signal, the RX device 130 may first estimate the effects (e.g., “channel response”) of the communications channel 120 on the received data signal. For some embodiments, the RX device 130 may estimate the channel response based on information provided in multiple fields of the preamble of a received data packet. More specifically, the RX device 130 may generate a first channel estimation based on a first set of information from the preamble, and may further generate a second channel estimation based on a second set of information from the preamble. The RX device 130 may then combine (e.g., average) the two channel estimations to determine the overall channel response of the communications channel 120.

For some embodiments, the preamble for each received data packet may include a set of known training data (e.g., for channel estimation purposes) as defined by the IEEE 802.11 specification. Accordingly, the RX device 130 may first estimate the channel response of the communications channel 120 based on conventional channel estimation techniques. The RX device 130 may then use additional information included in the preamble of the received data packet to further augment (e.g., improve upon) the estimated channel response.

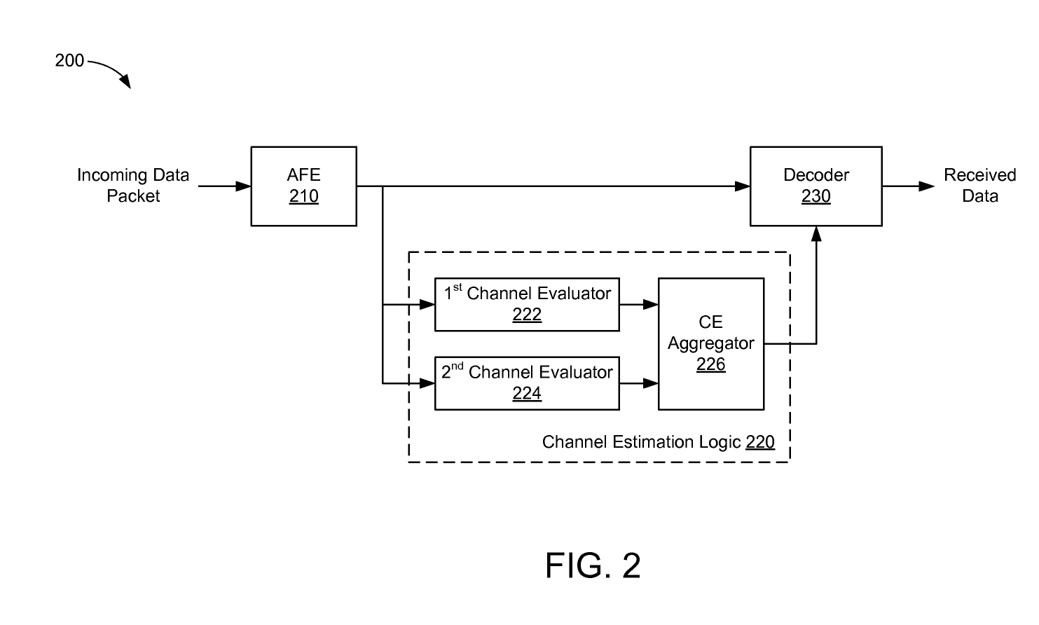

FIG. 2 is a block diagram of a receiver 200 for a communications device, in accordance with some embodiments. The receiver 200 includes an analog front end (AFE) 210, channel estimation logic 220, and a decoder 230. The AFE 210 may include circuitry (e.g., antennas, receivers, etc.) to receive data signals via a wireless communications medium. More specifically, the received data signals may correspond with an incoming data packet. The received data packet is then forwarded to the channel estimation logic 220 and decoder 230 for further processing.

The channel estimation logic 220 includes a first channel evaluator 222, a second channel evaluator 224, and a channel estimation (CE) aggregator 226. The channel evaluators 222 and 224 may each generate a separate channel estimation based on information provided in the preamble of the received data packet. More specifically, each channel evaluator may generate a respective channel estimation based on a different portion of the preamble of the received data packet.

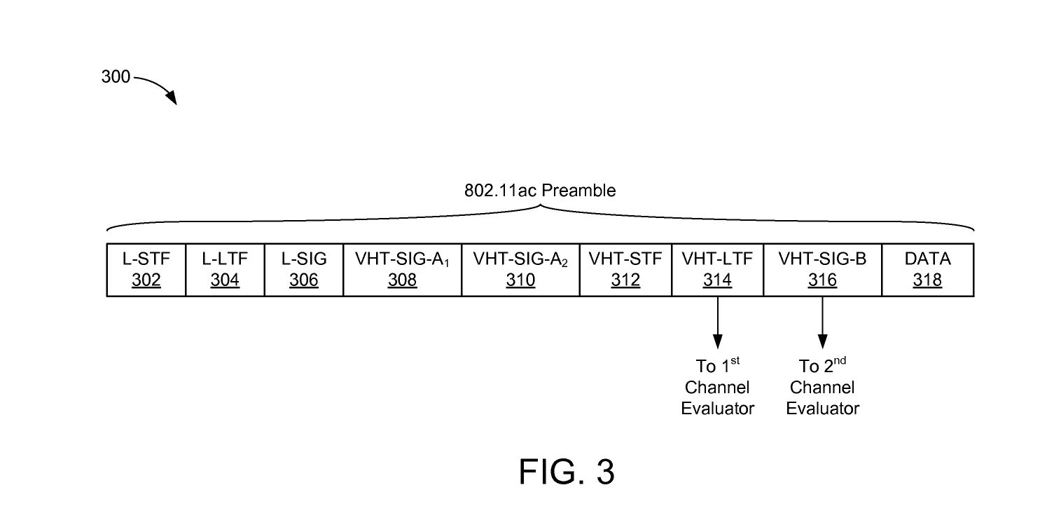

For example, FIG. 3 shows an example structure of a data packet preamble 300 as defined by the IEEE 802.11ac specification. The “ac” amendment to the IEEE 802.11 standard defines a number of Very High Throughput (VHT) protocols designed to provide significant improvements in achievable data rates over the previous amendment (e.g., IEEE 802.11n). For example, the preamble 300 includes a number of information fields 302-318 which may be used to implement VHT and/or legacy protocols (e.g., to maintain backwards-compatibility with devices implementing the legacy standard). More specifically, the preamble 300 may include a Legacy Short Training Field (L-STF) 302, a Legacy Long Training Field (L-LTF) 304, a Legacy Signal (L-SIG) field 306, a set of Very High Throughput Signal A (VHT-SIG-A) fields 308 and 310, a Very High Throughput Short Training Field (VHT-STF) 312, a Very High Throughput Long Training Field (VHT-LTF) 314, a Very High Throughput Signal B (VHT-SIG-B) field 316, and a data field 318.

For some embodiments, the channel estimation logic 220 may determine the channel response of the wireless channel based, at least in part, on the VHT-LTF 314 and the VHT-SIG-B field 316 of the preamble 300. For example, the information from the VHT-LTF 314 may be provided to the first channel evaluator 222, and the information from the VHT-SIG-B field 316 may be provided to the second channel evaluator 224. The VHT-LTF 314 may contain a set of known training data which may be used for determining a channel response of the communications channel (e.g., by conventional means). Accordingly, the first channel evaluator 222 may implement the following formula to determine the first channel estimation:

yᵢ=H_{LTF}pᵢ+nᵢ (1)

where yᵢ (e.g., for i={1, . . . , N}) represents each received training signal from the VHT-LTF 314, pᵢ represents the known value of each corresponding training signal, and nᵢ represents a noise component associated with each transmitted signal. The channel matrix H_{LTF} (e.g., the frequency domain channel estimation response) represents a transformation to the known training sequence P (e.g., where P=[pᵢ, . . . , p_{N}]^{T}) that results in the received sequence Y (e.g., where Y=[y₁, y_{N}]^{T}). Accordingly, the channel estimation may be determined by solving for H_{LTF}.

The VHT-SIG-B field 316 is primarily used for signaling user specific information in multi-user multiple-input multiple-output (MU-MIMO) data packets, but is included in all packets transmitted according to the IEEE 802.11ac specification for purposes of maintaining a single unified preamble format for VHT packets. More specifically, the VHT-SIG-B information is transmitted using a binary phase-shift keying (BPSK) modulation technique, which is highly resilient to noise and distortion in the wireless channel. Therefore, the VHT-SIG-B data may be received with a very high signal-to-noise ratio (SNR). Because the information contained in the VHT-SIG-B field often varies (e.g., depending on the receiving device), the second channel evaluator 224 may generate the second channel estimation by comparing the received VHT-SIG-B data with a hard-decision (and/or soft-decision) estimate of the VHT-SIG-B data.

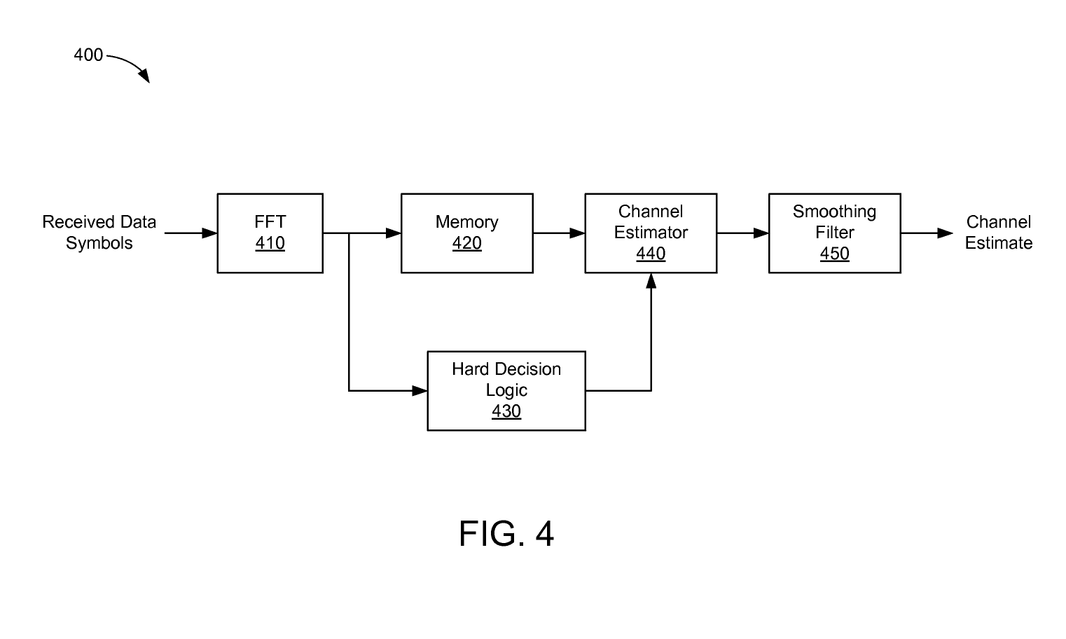

For example, FIG. 4 is a block diagram of a channel evaluator 400 which may be a more detailed embodiment of the second channel evaluator 224 (and/or the first channel evaluator 222 ) shown in FIG. 2. The channel evaluator 400 includes an FFT module 410, a memory 420, hard decision logic 430, and a channel estimator 440. The FFT module 410 performs a Fast Fourier Transform (FFT) on a set of received data symbols to convert the received signals from the time domain to the frequency domain. The memory 420 temporarily stores a copy of the received data symbols, while the hard decision logic 430 generates a hard decision estimate of the symbol values. For some embodiments, the received data symbols may be BPSK-modulated. Accordingly, the hard decision logic 430 may provide a reliable estimate of the actual values for the received data symbols.

The channel estimator 440 compares the received data symbols (e.g., stored in memory 420 ) with the hard decision estimates for the data symbols to produce a corresponding channel estimation. For example, where the received data symbols are from the VHT-SIG-B field 316 of an 802.11ac preamble 300, the channel estimator 440 may implement the following formula to determine the corresponding channel estimation:

xᵢ=H_{SJGB}dₜ+nᵢ (2)

where xᵢ (e.g., for i={1, . . . , N}) represents each received data symbol from the VHT-SIG-B field 316, dᵢ represents the hard-decision estimate for each corresponding symbol, and nᵢ represents a noise component associated with each transmitted signal. The channel matrix H_{SIGB} (e.g., the frequency domain channel estimation response) represents a transformation to the hard-decision estimates D (e.g., where D=[d₁, d_{N}]^{T}) that results in the received symbols X (e.g., wherein X=xₗ, x_{N}]^{T}). Accordingly, the channel estimation may be determined by solving for H_{SIGB}.

For some embodiments, the channel estimation generated by the channel estimator 440 may be passed through a smoothing filter 450 to help mitigate any estimation errors. For example, through channel smoothing, the effective SNR becomes:

$${SNR}_{sm = 1} = \frac{1}{{σ}^{2} + α * {σ}_{h}^{2}}$$

where α*σₕ² is the residual channel estimation error variance after smoothing (e.g., the smoothing gain). Further, for some embodiments, the hard-decision estimates dᵢ may be provided by a channel decoder output (e.g., in lieu of the hard decision logic 420 ).

Referring back to FIG. 2, the CE aggregator 226 may combine the channel estimations (e.g., H_{STF} and H_{SIGB}) generated by the respective channel evaluators 222 and 224 into a single overall estimate of the channel response for the communications channel. For example, each channel estimation represents an individual estimate of the channel response that is measured based on different information provided in the preamble 300. More specifically, because each channel estimation may be derived using a different channel estimation technique, the resulting channel estimations may differ from one another. Thus, to mitigate possible errors in each channel estimation technique, the CE aggregator 226 may average the channel estimations from each of the channel evaluators 222 and 224 to determine the overall channel response.

For some embodiments, the CE aggregator 226 may use the channel estimation (e.g., H^{SIGB}) from the second channel evaluator 224 to update or improve upon the channel estimation (e.g., H_{LTF}) from the first channel evaluator 222. For example, the CE aggregator 226 may determine the overall channel response as a weighted average of the channel estimations from each of the channel evaluators 222 and 224. For example, the updated channel response may be calculated as:

H_{update}=(1=α)H_{LTF}+αH_{SIGB}

where a represents a weighting value. For some embodiments, the weight given to each of the channel estimations may vary depending on the SNR associated with the communication. For example, channel estimations derived from the LTF 314 may be very reliable for low SNR (e.g., below an SNR threshold), whereas channel estimations derived from the VHT-SIG-B field 216 are more reliable for higher SNR (e.g., above or equal to the SNR threshold).

The final channel response (e.g., H_{update}) is provided to the decoder 230 and used to recover the received data. For example, the decoder 230 may apply the channel matrix H_{update} to received data signals from the data portion (e.g., payload) of the incoming data packet to recover the originally-transmitted data. For some embodiments, the channel response may be further transmitted to the TX device as channel state information (CSI).

It should be noted that, while specific channel estimation techniques have been described herein as utilizing information provided in the VHT-SIG-B field 316 to improve upon the channel estimation derived from the VHT-LTF 314, the present embodiments are not limited to such configurations. For example, in other embodiments, the second channel evaluator 224 may generate the second channel estimation based on information provided in any one of the preamble fields 302-318. Still further, in some embodiments, both of the channel evaluators 222 and 224 may generate respective channel estimations based on various combinations of information provided in the preamble fields 302-318.

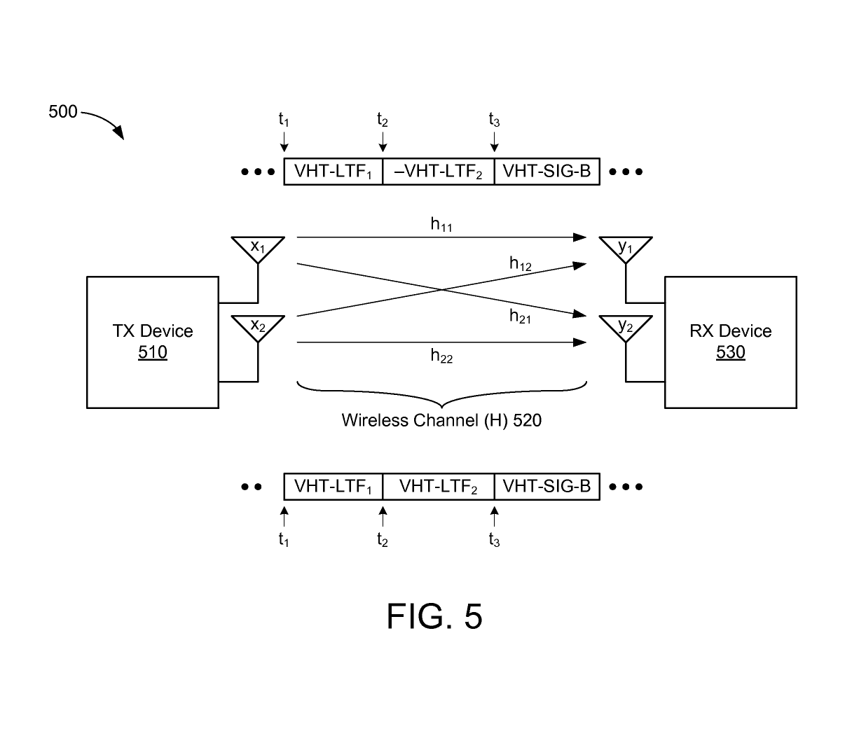

FIG. 5 shows a multiple-input multiple-output (MIMO) communications system 500 in accordance with some embodiments. A TX device 510 transmits a MIMO signal over a wireless channel 520 (e.g., represented by the channel matrix H) to an RX device 530. More specifically, MIMO wireless communications techniques are defined by the IEEE 802.11ac specification and may be used to transmit multiple streams of data, concurrently, over a wireless channel. MIMO communications offer many advantages over conventional communications techniques, including, for example, high capacity, extended coverage, increased diversity, and/or interference suppression. For example, through “beamforming” a transmitting device may utilize multiple antennas to focus energy (e.g., data signals) towards a receiving device.

For some embodiments, the TX device 510 may transmit a MIMO-encoded data packet via two antennas x₁ and x₂. The first antenna (x₁) transmits a data packet having a preamble that includes a first VHT-LTF (VHT-LTF₁), a second VHT-LTF (VHT-LTF₂), and a VHT-SIG-B field. Similarly, the second antenna (x₂) transmits a data packet having a preamble that also includes a VHT-LTF₁, a VHT-LTF₂, and a VHT-SIG-B field. It should be noted, however, that the polarity of the VHT-LTF₂ transmitted by the first and second antennas x₁ and x₂ are reversed (e.g., opposite of one another). The RX device 530 may receive the MIMO-encoded data packets via two antennas y₁ and y₂. Specifically, each of the antennas y₁ and y₂ may receive a combination of the spatial streams transmitted by the antennas x₁ and x₂. Accordingly, the channel matrix H may be represented as a 2×2 matrix (e.g., or an MxM matrix, for M spatial streams):

$$H = [ \begin{matrix}{h}_{11} & {h}_{12} \\ {h}_{21} & {h}_{22}\end{matrix} ]$$

Because a data packet is transmitted over two spatial streams, the RX device 530 may utilize at least two sets of data in the preamble (e.g., received at two separate times) to calculate the channel matrix H. For example, using conventional channel estimation techniques, the channel matrix H may be calculated based on the information in provided in VHT-LTF₁ (e.g., at time t₁) and the information provided in VHT-LTF₂ (e.g., at time t₂):

$$\begin{matrix}At time {t}_{1} \{ \begin{matrix}{y}_{1 , t 1} = {h}_{11} {x}_{LTF 1} + {h}_{12} {x}_{LTF 1} + {n}_{1 , t 1} \\ {y}_{2 , t 1} = {h}_{21} {x}_{LTF 1} + {h}_{22} {x}_{LTF 1} + {n}_{2 , t 1}\end{matrix} & ( 3 ) \\ At time {t}_{2} \{ \begin{matrix}{y}_{1 , t 2} = - {h}_{11} {x}_{LTF 2} + {h}_{12} {x}_{LTF 2} + {n}_{1 , t 2} \\ {y}_{2 , t 2} = - {h}_{21} {x}_{LTF 2} + {h}_{22} {x}_{LTF 2} + {n}_{2 , t 2}\end{matrix} & ( 4 )\end{matrix}$$

where X_{LTF1} represents the information transmitted in VHT-LTF₁ and X_{LTF2} represents the information transmitted in VHT-LTF₂. Solving for h₁₁, h₁₂, h₂₁, and h₂₂ yields the estimated channel response for the wireless channel (e.g., channel matrix H).

For some embodiments, the RX device 530 may generate an improved channel response estimate by using additional information in the preamble to augment the determination of the channel matrix H. For example, the VHT-SIG-B field substantially tracks (e.g., experiences the same channel effects as) the VHT-LTF₁. Thus, for some embodiments, the information provided in the VHT-SIG-B field may be used to augment or improve upon the equivalent channel response derived from the VHT-LTF₁ data.

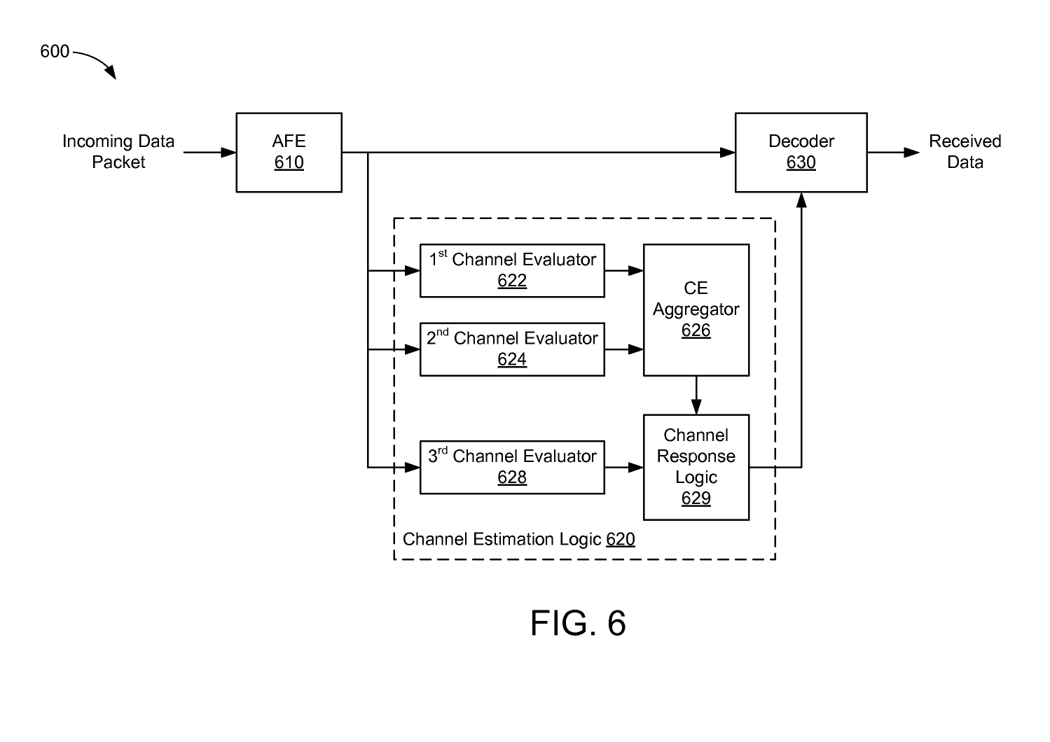

FIG. 6 is a block diagram of a receiver 600 for a MIMO communications device, in accordance with some embodiments. The receiver 600 includes an AFE 610, channel estimation logic 620, and a decoder 630. The AFE 610 may include circuitry (e.g., antennas, receivers, etc.) to receive data signals via a wireless communications medium. More specifically, the received data signals may correspond with an incoming data packet. The received data packet is then forwarded to the channel estimation logic 620 and decoder 630 for further processing.

The channel estimation logic 620 includes a first channel evaluator 622, a second channel evaluator 624, a CE aggregator 626, a third channel evaluator 628, and channel response logic 629. The channel evaluators 622, 624, and 628 may each generate an equivalent channel response based on information provided in the preamble of the received data packet. More specifically, each channel evaluator may generate a respective equivalent channel response based on a different portion of the preamble of the received data packet.

For some embodiments, the channel estimation logic 620 may determine the channel response of the communications channel based, at least in part, on information provided in the VHT-LTF₁, the VHT-LTF₂, and the VHT-SIG-B field of the preamble (e.g., as shown in FIG. 5). For example, the information from the VHT-LTF₁ may be provided to the first channel evaluator 622, the information from the VHT-SIG-B field may be provided to the second channel evaluator 624, and the information from the VHT-LTF₂ may be provided to the third channel evaluator 626. As described above, the VHT-LTF₁ and VHT-LTF₂ may contain a set of known training data which may be used for determining a channel response of the communications channel (e.g., by conventional means). More specifically, the VHT-LTF₁ training sequence may be substantially similar, if not identical, to the VHT-LTF₂ training sequence.

For some embodiments, the first channel evaluator 622 may determine the equivalent channel response h̅₁̅ and h̅₂̅ for the wireless channel, at time t₁, based on Equation 3 (e.g., where h̅₁̅=h₁₁+h₁₂ and h̅₂̅=h₂₁+h₂₂). Similarly, the third channel evaluator 628 may determine the equivalent channel response h̅₃̅ and h̅₄̅ for the wireless channel, at time t₂, based on Equation 4 (e.g., where h̅₃̅=−h₁₁+h₁₂ and h̅₄̅=−h₂₁+h₂₂). Further, for some embodiments, the second channel evaluator 624 may determine the equivalent channel response h₁ and h₂ for the wireless channel, at time t₃, based on information provided in the VHT-SIG-B field of the received data packet.

As described above, the VHT-SIG-B field substantially tracks the VHT-LTF₁. Thus, the channel response based on the VHT-SIG-B field may be expressed as:

$$At time {t}_{3} \{ \begin{matrix}{y}_{1 , t 3} = {h}_{11} {x}_{SIGB} + {h}_{12} {x}_{SIGB} + {n}_{1 , t 3} \\ {y}_{2 , t 3} = {h}_{21} {x}_{SIGB} + {h}_{22} {x}_{SIGB} + {n}_{2 , t 3}\end{matrix} \qquad ( 5 )$$

where X_{SIGB} represents the information transmitted in the VHT-SIG-B field. For some embodiments, the RX device 530 may apply a hard decision estimate on the received VHT-SIG-B data to determine the values for X_{SIGB} (e.g., as described above with respect to FIG. 4).

For some embodiments, the CE aggregator 626 may average the equivalent channel responses from the first and second channel evaluators 622 and 624. As described above, averaging the equivalent channel responses derived based on information from both the VHT-LTF₁ and the VHT-SIG-B fields may produce a more accurate overall estimate of the corresponding channel response. For example, the CE aggregator 626 may implement the following formulas to determine an updated equivalent channel response h̅_̅{̅1̅,̅u̅p̅}̅ and h̅_̅{̅2̅,̅u̅p̅}̅ for the corresponding wireless channel:

$$\{ \begin{matrix}\overline{{h}_{1 , up}} = \frac{1}{2} ( \overline{{h}_{1 , LTF 1}} + \overline{{h}_{1 , SIGB}} ) \\ \overline{{h}_{2 , up}} = \frac{1}{2} ( \overline{{h}_{2 , LTF 1}} + \overline{{h}_{2 , SIGB}} )\end{matrix}$$

where h̅_̅{̅1̅,̅L̅T̅F̅1̅}̅ and h̅_̅{̅2̅,̅L̅T̅F̅1̅}̅ represent the equivalent channel response generated by the first channel evaluator 622, and h̅_̅{̅1̅,̅S̅J̅G̅B̅}̅ and h̅_̅{̅2̅,̅S̅J̅G̅B̅}̅ represent the equivalent channel response generated by the second channel evaluator 624. The updated noise components n_{1,up} and n_{2,up} may further be expressed as:

$$\{ \begin{matrix}{n}_{1 , up} = \frac{1}{2} ( {n}_{1 , t 1} + {n}_{1 , t 3} ) \\ {n}_{2 , up} = \frac{1}{2} ( {n}_{2 , t 1} + {n}_{2 , t 3} )\end{matrix}$$

Finally, the channel response logic 629 may combine the updated equivalent channel response h̅_̅{̅1̅,̅u̅p̅}̅ and h̅_̅{̅2̅,̅u̅p̅}̅ from the CE aggregator 626 with the equivalent channel response h̅₃̅ and h̅₄̅ from the third channel evaluator 628 to determine the overall channel response of the corresponding wireless channel. For example, the channel response logic 629 may calculate the components (e.g., h₁₁, h₁₂, h₂₁, and h₂₂) of the channel matrix H based on the following formula:

$$\{ \begin{matrix}{h}_{11} = \frac{{y}_{1 , t 1} - {y}_{1 , t 2}}{2 {x}_{LTF}} = \frac{( \overline{{h}_{1}} - \overline{{h}_{3}} ) {x}_{LTF} + {n}_{1 , t 1} - {n}_{1 , t 2}}{2 {x}_{LTF}} \\ {h}_{12} = \frac{{y}_{1 , t 1} + {y}_{1 , t 2}}{2 {x}_{LTF}} = \frac{( \overline{{h}_{1}} + \overline{{h}_{3}} ) {x}_{LTF} + {n}_{1 , t 1} + {n}_{1 , t 2}}{2 {x}_{LTF}} \\ {h}_{21} = \frac{{y}_{2 , t 1} - {y}_{2 , t 2}}{2 {x}_{LTF}} = \frac{( \overline{{h}_{2}} - \overline{{h}_{4}} ) {x}_{LTF} + {n}_{2 , t 1} - {n}_{2 , t 2}}{2 {x}_{LTF}} \\ {h}_{22} = \frac{{y}_{2 , t 1} + {y}_{2 , t 2}}{2 {x}_{LTF}} = \frac{( \overline{{h}_{2}} + \overline{{h}_{4}} ) {x}_{LTF} + {n}_{2 , t 1} + {n}_{2 , t 2}}{2 {x}_{LTF}}\end{matrix}$$

where x_{LTF} represents a known training sequence to be used in determining the channel response (e.g., assuming the same training sequence is included in both VHT-LTF₁ and VHT-LTF₂).

After substituting h̅_̅{̅1̅,̅u̅p̅}̅ and h̅_̅{̅2̅,̅u̅p̅}̅ for h̅₁̅ and h̅₂̅, respectively, (and substituting n_{1,up} and n_{2,up} for n_{1,t1} and n_{2,t1}, respectively) the above equation becomes:

$$\{ \begin{matrix}{h}_{11} = \frac{( \frac{1}{2} \overline{{h}_{1 , LTF}} + \frac{1}{2} \overline{{h}_{1 , SIGB}} - \overline{{h}_{3}} ) {x}_{LTF} + \frac{1}{2} {n}_{1 , t 1} + \frac{1}{2} {n}_{1 , t 3} - {n}_{1 , t 2}}{2 {x}_{LTF}} \\ {h}_{12} = \frac{( \frac{1}{2} \overline{{h}_{1 , LTF}} + \frac{1}{2} \overline{{h}_{1 , SIGB}} + \overline{{h}_{3}} ) {x}_{LTF} + \frac{1}{2} {n}_{1 , t 1} + \frac{1}{2} {n}_{1 , t 3} + {n}_{1 , t 2}}{2 {x}_{LTF}} \\ {h}_{21} = \frac{( \frac{1}{2} \overline{{h}_{2 , LTF}} + \frac{1}{2} \overline{{h}_{2 , SIGB}} - \overline{{h}_{4}} ) {x}_{LTF} + \frac{1}{2} {n}_{2 , t 1} + \frac{1}{2} {n}_{2 , t 3} - {n}_{2 , t 2}}{2 {x}_{LTF}} \\ {h}_{22} = \frac{( \frac{1}{2} \overline{{h}_{2 , LTF}} + \frac{1}{2} \overline{{h}_{2 , SIGB}} - \overline{{h}_{4}} ) {x}_{LTF} + \frac{1}{2} {n}_{2 , t 1} + \frac{1}{2} {n}_{2 , t 3} + {n}_{2 , t 2}}{2 {x}_{LTF}}\end{matrix}$$

which may be further reduced to:

$$\{ \begin{matrix}{h}_{11} = \frac{( \frac{1}{2} \overline{{h}_{1 , LTF}} + \frac{1}{2} \overline{{h}_{1 , SIGB}} - \overline{{h}_{3}} ) + \frac{1}{2} {n}_{1 , t 1}^{′} + \frac{1}{2} {n}_{1 , t 3}^{′} - {n}_{1 , t 2}^{′}}{2} \\ {h}_{12} = \frac{( \frac{1}{2} \overline{{h}_{1 , LTF}} + \frac{1}{2} \overline{{h}_{1 , SIGB}} + \overline{{h}_{3}} ) + \frac{1}{2} {n}_{1 , t 1}^{′} + \frac{1}{2} {n}_{1 , t 3}^{′} + {n}_{1 , t 2}^{′}}{2} \\ {h}_{21} = \frac{( \frac{1}{2} \overline{{h}_{1 , LTF}} + \frac{1}{2} \overline{{h}_{2 , SIGB}} - \overline{{h}_{4}} ) + \frac{1}{2} {n}_{2 , t 1}^{′} + \frac{1}{2} {n}_{2 , t 3}^{′} - {n}_{2 , t 2}^{′}}{2} \\ {h}_{22} = \frac{( \frac{1}{2} \overline{{h}_{1 , LTF}} + \frac{1}{2} \overline{{h}_{2 , SIGB}} + \overline{{h}_{4}} ) + \frac{1}{2} {n}_{2 , t 1}^{′} + \frac{1}{2} {n}_{2 , t 3}^{′} - {n}_{2 , t 2}^{′}}{2}\end{matrix}$$

Therefore, the channel response logic 620 may determine the overall channel response (e.g., channel matrix H) based on the equivalent channel responses generated by the first channel evaluator 622 (e.g., h̅_̅{̅1̅,̅L̅T̅F̅1̅}̅ and h̅_̅{̅2̅,̅L̅T̅F̅1̅}̅), by the second channel evaluator 624 (e.g., h̅_̅{̅1̅,̅S̅I̅G̅B̅}̅ and h̅_̅{̅2̅,̅S̅I̅G̅B̅}̅), and by the third channel evaluator 626 (e.g., h̅₃̅ and h̅₄̅).

The final channel response (H) is provided to the decoder 630 and used to recover the received data. For example, the decoder 630 may apply the channel matrix H to received data signals from the data portion (e.g., payload) of the incoming data packet to recover the originally-transmitted data. For some embodiments, the channel response may be further transmitted to the TX device as channel state information. Further, it should be noted that the multi-spatial stream channel-estimation techniques described herein may be applied to MIMO communications via any number (M) of spatial streams, with very minor modifications.

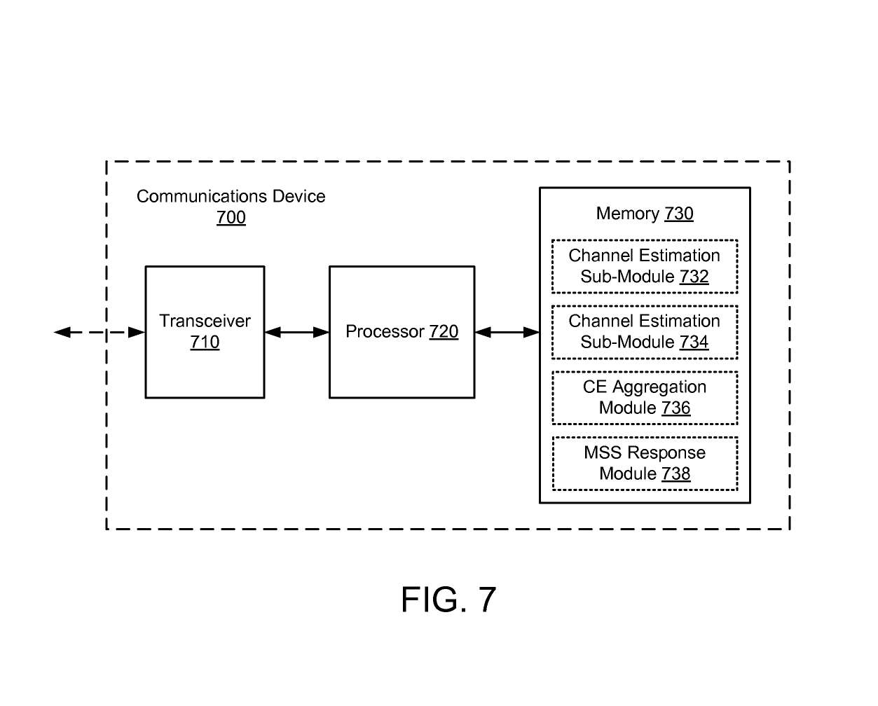

FIG. 7 shows a block diagram of a wireless communications device 700 in accordance with some embodiments. The communications device 700 includes a transceiver 710, a processor 720, and a memory 730. The transceiver 710 may be used to communicate wirelessly with one or more STAs, with one or more APs, and/or with other suitable wireless devices. Processor 720, which is coupled to transceiver 710 and memory 730, may be any suitable processor capable of executing scripts or instructions of one or more software programs stored in the communications device 700 (e.g., within memory 730 ).

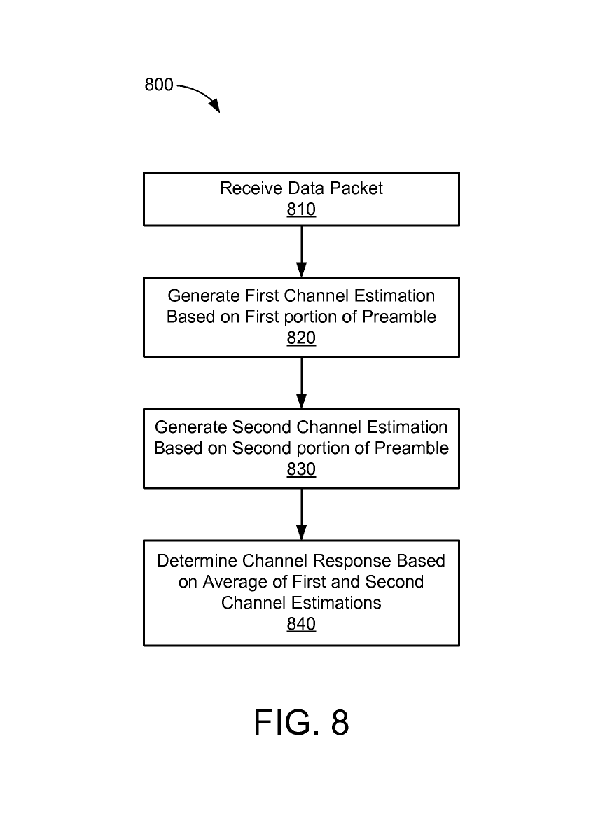

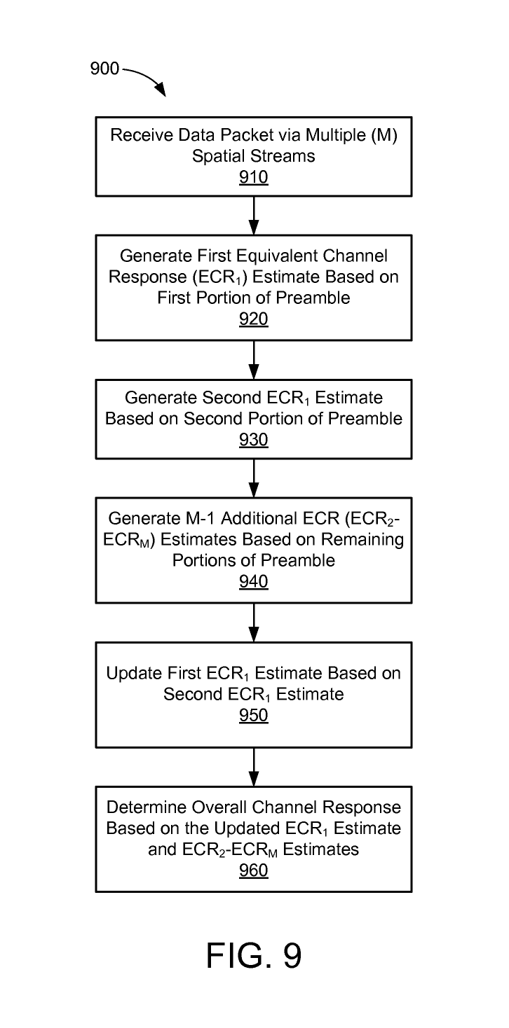

Memory 730 may include a non-transitory computer-readable medium (e.g., one or more nonvolatile memory elements, such as EPROM, EEPROM, Flash memory, a hard drive, etc.) that may store the following software modules:
a first channel estimation sub-module 732 to generate a first channel estimation for a corresponding wireless communications channel based on a first portion of a preamble of a received data packet;
a second channel estimation sub-module 734 to generate a second channel estimation for the wireless communications channel based on a second portion of the preamble;
a channel estimation (CE) aggregation module 736 to combine the first and second channel estimations into a single channel response estimate; and
a multi-spatial stream (MSS) response module 738 to determine the channel response in a MIMO environment.
   Each software module includes instructions that, when executed by processor 720, causes the communications device 700 to perform the corresponding functions. The non-transitory computer-readable medium of memory 730 thus includes instructions for performing all or a portion of the operations described below with respect to FIGS. 8 and 9.

Processor 720, which is shown in the example of FIG. 7 as coupled to transceiver 710 and memory 730, may be any suitable processor capable of executing scripts or instructions of one or more software programs stored in the communications device 700 (e.g., within memory 730 ). For example, processor 720 may execute the first channel estimation sub-module 732 to generate a first channel estimation for a corresponding wireless communications channel based on a first portion of a preamble of a received data packet. Processor 720 may also execute the second channel estimation sub-module 734 to generate a second channel response estimate for the wireless communications channel based on a second portion of the preamble. Further, the processor 720 may execute the CE aggregation module 736 to combine the first and second channel estimations into a single channel response estimate. Still further, the processor 720 may execute the MSS response module 738 to determine the channel response in a MIMO environment.

FIG. 8 is an illustrative flow chart depicting a method 800 of determining the channel response of a wireless communications channel, in accordance with some embodiments. With reference, for example, to FIG. 2, the method 800 may be implemented by the receiver 200 to determine the channel effects on an incoming data packet. Specifically, the receiver 200 may first receive a data packet via a wireless communications channel ( 810 ). For example, the AFE 210 may receive a set of data signals corresponding with an incoming data packet. For some embodiments, the received data packet may include a preamble that complies with the IEEE 802.11ac specification (e.g., preamble 300 shown in FIG. 3). As described above, the wireless channel may introduce noise and/or other types of interference into the received data signals.

The receiver 200 may then generate a first channel estimation for the corresponding wireless channel based on a first portion of a preamble of the received data packet ( 820 ). For some embodiments, the channel estimation logic 220 (e.g., specifically, the first channel evaluator 222 ) may generate the first channel estimation based on information provided in the VHT-LTF 314 of the preamble 300. As described above, the VHT-LTF 314 may contain a set of known training data to be used for determining a channel response of the communications channel (e.g., by conventional means). Accordingly, the first channel evaluator 222 may determine the first channel estimation based, at least in part, on the received training signals and the known values for the training signals (e.g., using Equation 1).

The receiver 200 may further generate a second channel estimation for the corresponding wireless channel based on a second portion of the preamble of the received data packet (830). For some embodiments, the channel estimation logic 220 (e.g., specifically, the second channel evaluator 224) may generate the second channel estimation based on information provided in the VHT-SIG-B field 316 of the preamble 300. As described above, the VHT-SIG-B field 316 may contain user-specific data. Thus, the second channel evaluator 224 may first determine a hard-decision estimation of the received data signals (e.g., as described above with respect to FIG. 4), and then determine the second channel estimation based, at least in part, on the received data signals from the VHT-SIG-B field 316 and the hard-decision estimates for the corresponding data (e.g., using Equation 2).

Finally, the receiver 200 may determine the overall channel response of the wireless channel, at least in part, by combining the first and second channel estimations (840). As described above, each channel estimation represents an individual estimate of the channel response that is measured based on different information provided in the preamble 300. Thus, for some embodiments, the CE aggregator 226 may combine the first and second channel estimations into a single estimated channel response (e.g., to produce a more reliable channel estimation). For some embodiments, the CE aggregator 226 may determine the overall channel response as a weighted average of the first and second channel estimations (e.g., as described above with respect to FIG. 2).

FIG. 9 is an illustrative flow chart depicting a method 900 of determining the channel response of a MIMO communications channel, in accordance with some embodiments. With reference, for example, to FIG. 6, the method 900 may be implemented by the receiver 600 to determine the channel effects on an incoming data packet received via multiple spatial streams. Specifically, the receiver 600 may first receive a data packet via a number (M) of spatial streams ( 910 ). For example, the AFE 610 may receive multiple concurrent data signals corresponding with an incoming data packet. For some embodiments, the data packet be transmitted in accordance with the IEEE 802.11ac specification (e.g., as described above with respect to FIG. 5). Accordingly, the received data packet may include a preamble having a VHT-LTF₁, a VHT-LTF₂, and a VHT-SIG-B field.

The receiver 600 may generate a first equivalent channel response (ECR₁) estimate based on a first portion of the preamble (920). For some embodiments, the channel estimation logic 620 (e.g., specifically, the first channel evaluator 622) may generate the first ECR₁ estimate based on information provided in the VHT-LTF₁ of the preamble. As described above, the VHT-LTF₁ may contain a set of known training data to be used for determining a channel response of the communications channel (e.g., by conventional means). Accordingly, the first channel evaluator 622 may determine the first ECR₁ estimate (h̅₁̅ and h̅₂̅) based on the received training signals and the known values for the training signals (e.g., using Equation 3).

The receiver 600 may generate a second ECR₁ estimate based on a second portion of the preamble (930). For some embodiments, the channel estimation logic 620 (e.g., specifically, the second channel evaluator 624 ) may generate the second ECR₁ estimate based on information provided in the VHT-SIG-B field of the preamble. As described above, the VHT-SIG-B field may contain user-specific data. Thus, the second channel evaluator 624 may first determine a hard-decision (and/or soft-decision) estimate of the received data signals (e.g., as described above with respect to FIG. 4), and then determine the second ECR₁ estimate based, at least in part, on the received data signals from the VHT-SIG-B field and the hard-decision (and/or soft-decision) estimates for the corresponding data (e.g., using Equation 5).

The receiver 600 may further generate a number (M-1) of additional ECR (e.g., ECR₂-ECR_{M}) estimates based on one or more remaining portions of the preamble (940). For example, the preamble of a MIMO data packet may include a VHT-LTF for each of M spatial streams. For some embodiments, the channel estimation logic 620 (e.g., specifically, the third channel evaluator 628) may generate an ECR₂ estimate based on information provided in the VHT-LTF₂ of the preamble. As described above, the VHT-LTF₂ may contain a set of known training data to be used for determining a channel response of the communications channel (e.g., by conventional means). Accordingly, the third channel evaluator 628 may determine the ECR₂ estimate (h̅₃̅ and h̅₄̅) based on the received training signals and the known values for the training signals (e.g., using Equation 4).

The receiver 600 may then update the first ECR₁ estimate based on the second ECR₁ estimate (950). As described above, the VHT-SIG-B field substantially tracks the VHT-LTF₁. Thus, information from the VHT-SIG-B field may be used to augment or improve upon the ECR₁ estimate derived from the VHT-LTF₁ data. For example, the CE aggregator 626 may average the first ECR₁ estimate (e.g., h̅_̅{̅1̅,̅L̅T̅F̅1̅}̅ and h̅_̅{̅2̅,̅L̅T̅F̅1̅}̅) and the second ECR₁ estimate (e.g., h̅_̅{̅1̅,̅S̅I̅G̅B̅}̅ and h̅_̅{̅2̅,̅S̅I̅G̅B̅}̅) to produce an updated ECR estimate (e.g., h̅_̅{̅1̅,̅u̅p̅}̅ and h̅_̅{̅2̅,̅u̅p̅}̅). As described above, combining the equivalent channel responses derived based on information from the VHT-LTF₁ and the VHT-SIG-B fields may produce a more accurate overall estimate of the corresponding channel response.

Finally, the receiver 600 may determine the overall channel response for the communications channel based on the updated ECR₁ estimate and the remaining ECR (e.g., ECR₂-ECR_{M}) estimates (960). For example, the channel response logic 629 may combine the updated ECR₁ estimates with the ECR₂ estimate to determine the components (e.g., h₁₁, h₁₂, h₂₁, and h₂₂) of the representative channel matrix H (e.g., as described above with reference to FIG. 6). Although specific examples have been described with respect to 2-stream MIMO communications, the method 900 may be applied to MIMO communications involving any number M of spatial streams and/or target device (e.g., including SU-MIMO and/or MU-MIMO communications).

In the foregoing specification, the present embodiments have been described with reference to specific exemplary embodiments thereof. It will, however, be evident that various modifications and changes may be made thereto without departing from the broader scope of the disclosure as set forth in the appended claims. For example, the method steps depicted in the flow charts of FIGS. 8 and 9 may be performed in other suitable orders, multiple steps may be combined into a single step, and/or some steps may be omitted. The specification and drawings are, accordingly, to be regarded in an illustrative sense rather than a restrictive sense.

What is claimed is:

1. A method of determining a channel response of a communications channel, the method comprising:
receiving a data packet via the communications channel;
generating a first channel estimation based at least in part on a first portion of a preamble of the received data packet;
generating a second channel estimation based at least in part on a second portion of the preamble; and
determining the channel response of the communications channel based at least in part on a combination of the first channel estimation and the second channel estimation.

2. The method of claim 1, wherein the first portion of the preamble includes a set of known data, and wherein the second portion of the preamble includes a set of user-specific data.

3. The method of claim 2, wherein the first portion of the preamble corresponds with a Long Training Field (LTF).

4. The method of claim 2, wherein the second portion of the preamble corresponds with a Very High Throughput Signal B (VHT-SIG-B) field.

5. The method of claim 2, wherein generating the second channel estimation comprises:
determining a hard decision estimate for each data symbol of a received set of data symbols from the second portion of the preamble; and
comparing the received data symbols with the hard decision estimates, wherein the second channel estimation corresponds with a transformation to the hard decision estimates which results in the received data symbols.

6. The method of claim 1, wherein determining the channel response of the communications channel comprises:
determining the channel response based on a weighted average of the first channel estimation and the second channel estimation.

7. The method of claim 6, wherein the first channel estimation and the second channel estimation are given equal weight when a signal-to-noise ratio (SNR) of the communications channel is above a threshold level.

8. The method of claim 6, wherein the first channel estimation is given greater weight than the second channel estimation when the SNR is equal to or below a threshold level.

9. The method of claim 1, wherein the data packet is received via a plurality of spatial streams.

10. The method of claim 9, wherein determining the channel response of the communications channel comprises:
determining an equivalent channel response based on an average of the first channel estimation and the second channel estimation;
generating a third channel estimation based on a third portion of the preamble of the received data packet; and
determining the channel response based on a combination of the equivalent channel response and the third channel estimation.

11. A computing device, comprising:
a memory element storing instructions for determining a channel response of a communications channel; and
one or more processors that, upon executing the instructions, cause the computing device to:
receive a data packet via the communications channel;
generate a first channel estimation based at least in part on a first portion of a preamble of the received data packet;
generate a second channel estimation based at least in part on a second portion of the preamble; and
determine the channel response of the communications channel based at least in part on a combination of the first channel estimation and the second channel estimation.

12. The computing device of claim 11, wherein the first portion of the preamble includes a set of known data, and wherein the second portion of the preamble includes a set of user-specific data.

13. The computing device of claim 12, wherein the first portion of the preamble corresponds with a Long Training Field (LTF), and wherein the second portion of the preamble corresponds with a Very High Throughput Signal B (VHT-SIG-B) field.

14. The computing device of claim 12, wherein execution of the instructions to generate the second channel estimation causes the device to:
determine a hard decision estimate for each data symbol of a received set of data symbols from the second portion of the preamble; and
compare the received data symbols with the hard decision estimates, wherein the second channel estimation corresponds with a transformation to the hard decision estimates which results in the received data symbols.

15. The computing device of claim 11, wherein execution of the instructions to determine the channel response of the communications channel causes the device to:
determine the channel response based on a weighted average of the first channel estimation and the second channel estimation.

16. The computing device of claim 15, wherein the first channel estimation and the second channel estimation are given equal weight when a signal-to-noise ratio (SNR) of the communications channel is above an SNR threshold.

17. The computing device of claim 15, wherein the first channel estimation is given greater weight than the second channel estimation when the SNR is equal to or below an SNR threshold.

18. The computing device of claim 13, wherein the data packet is received via a plurality of spatial streams.

19. The computing device of claim 18, wherein execution of the instructions to determine the channel response of the communications channel causes the device to:
determine an equivalent channel response based on an average of the first channel estimation and the second channel estimation;
generate a third channel estimation based on a third portion of the preamble of the received data packet; and
determine the channel response based on a combination of the equivalent channel response and the third channel estimation.

20. A non-volatile computer-readable storage medium containing program instructions that, when executed by a processor of a communications device, causes the communications device to:
receive a data packet via the communications channel;
generate a first channel estimation based at least in part on a first portion of the preamble of the received data packet;
generate a second channel estimation based at least in part on a second portion of the preamble; and
determine the channel response of the communications channel based at least in part on a combination of the first channel estimation and the second channel estimation.
